(19) United States
(12) Patent Application Publication
(10) Pub. No.: US 2025/0046216 A1
(43) Pub. Date: Feb. 6, 2025

(54) METHOD FOR GENERATING TEACHING PROGRAM AND APPARATUS FOR GENERATING TEACHING PROGRAM

(71) Applicant: Kabushiki Kaisha Kobe Seiko Sho (Kobe Steel, Ltd.), Kobe-shi (JP)

(72) Inventor: Masatoshi HIDA, Kobe-shi (JP)

(73) Assignee: Kabushiki Kaisha Kobe Seiko Sho (Kobe Steel, Ltd.), Kobe-shi (JP)

(21) Appl. No.: 18/760,111

(22) Filed: Jul. 1, 2024

(30) Foreign Application Priority Data
Jul. 31, 2023 (JP) 2023-124707

(51) Int. Cl. G09B 25/02

(52) U.S. Cl. CPC G09B 25/02

(57) ABSTRACT

Reduced workload on a user can be achieved when a sensing-related teaching program is to be generated. A method for generating a teaching program that defines sensing operation includes a setting step for setting a sensing position at a surface of a workpiece, and a generating step for generating a teaching program of the sensing operation based on the sensing position set in the setting step. The sensing position is set within a range in which a maximum permissible amount for an error of the workpiece and a permissible range preliminarily defined with respect to a direction of the error are included in the surface.

### BACKGROUND OF THE INVENTION

### 1. Field of the Invention

The present invention relates to methods for generating teaching programs and apparatuses for generating teaching programs.

### 2. Description of the Related Art

In the related art, various techniques have been proposed for the purpose of achieving efficient teaching processes with respect to industrial robots of a teaching playback type. An example of such an industrial robot is a welding robot. For example, with regard to welding using a welding robot, a known method for correcting an error of a workpiece involves performing touch-sensing using a welding wire. When this correction is to be performed, for example, the position to be sensed and the sensing pattern need to be set from the shape of the workpiece and the groove shape of a welding area.

For example, Japanese Unexamined Patent Application Publication No. 2002-149215 discloses a configuration that selects a desired sensing pattern from a preset sensing pattern group and sets an optimal sensing path by selecting a sensing path pattern corresponding to the sensing pattern.

### SUMMARY OF THE INVENTION

In the technique according to Japanese Unexamined Patent Application Publication No. 2002-149215, master data and an operation pattern need to be registered in advance. Therefore, with regard to the workpiece to be sensed, additional registration occurs for a non-assumed shape or pattern. Moreover, generating a teaching program by selecting an appropriate operation pattern from many registered operation patterns increases the workload on the operator and requires high proficiency.

An object of the present invention is to enable reduced workload on a user when generating a sensing-related teaching program.

In order to solve the aforementioned problems, the present invention has the following configuration. Specifically, a method for generating a teaching program that defines sensing operation comprises a setting step for setting a sensing position at a surface of a workpiece, and a generating step for generating a teaching program of the sensing operation based on the sensing position set in the setting step. The sensing position is set within a range in which a maximum permissible amount for an error of the workpiece and a permissible range preliminarily defined with respect to a direction of the error are included in the surface.

Another aspect of the present invention has the following configuration. Specifically, an apparatus for generating a teaching program that defines sensing operation comprises setting means for setting a sensing position at a surface of a workpiece, and generating means for generating a teaching program of the sensing operation based on the sensing position set by the setting means. The sensing position is set within a range in which a maximum permissible amount for an error of the workpiece and a permissible range preliminarily defined with respect to a direction of the error are included in the surface.

The present invention enables reduced workload on a user when generating a sensing-related teaching program.

### BRIEF DESCRIPTION OF THE DRAWINGS

FIG. 1 schematically illustrates an example of a system configuration according to an embodiment of the present invention;

FIG. 2 is a block diagram illustrating a configuration example of a robot controller according to an embodiment of the present invention;

FIG. 3A schematically illustrates an example of a groove shape (T-joint fillet) according to an embodiment of the present invention;

FIG. 3B schematically illustrates an example of a groove shape (step fillet) according to an embodiment of the present invention;

FIG. 3C schematically illustrates an example of a groove shape (T-joint with single bevel groove) according to an embodiment of the present invention;

FIG. 3D schematically illustrates an example of a groove shape (butt joint with square groove) according to an embodiment of the present invention;

FIG. 3E schematically illustrates an example of a groove shape (butt joint with single V groove) according to an embodiment of the present invention;

FIG. 3F schematically illustrates an example of a groove shape (butt joint with single bevel groove) according to an embodiment of the present invention;

FIG. 4 is a table illustrating a correspondence example of a joint-groove type according to an embodiment of the present invention;

FIG. 5 is a table illustrating an example of a sensing-point setting pattern based on the joint-groove type according to an embodiment of the present invention;

FIG. 6A schematically illustrates how a Z-direction sensing point is set in accordance with an embodiment of the present invention;

FIG. 6B schematically illustrates how a Y-direction sensing point is set in accordance with an embodiment of the present invention;

FIG. 6C schematically illustrates how the Y-direction sensing point is set in accordance with an embodiment of the present invention;

FIG. 6D schematically illustrates how an X-direction sensing point is set in accordance with an embodiment of the present invention;

FIG. 6E schematically illustrates how the X-direction sensing point is set in accordance with an embodiment of the present invention; and

FIG. 7 is a flowchart of a teaching-program generating process according to an embodiment of the present invention.

### DESCRIPTION OF THE PREFERRED EMBODIMENTS

Embodiments of the present invention will be described below with reference to the drawings. The embodiments to be described below are used for explaining the present invention and are not intended to limit the interpretation of the present invention. Furthermore, not all of the components described in each embodiment are essential components for solving the problem of the present invention. Moreover, in the drawings, identical elements have corresponding relationships by being given the same reference signs.

### Configuration of Welding System

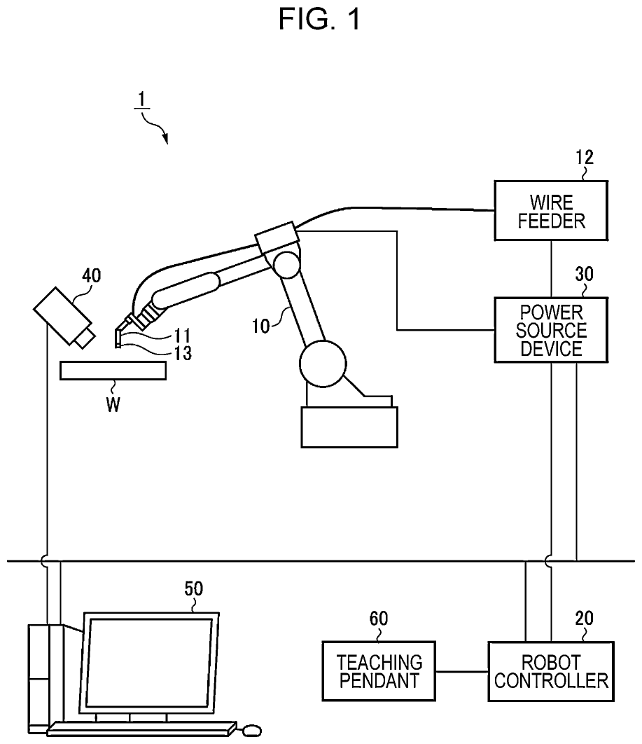

FIG. 1 illustrates a configuration example of a welding system 1 according to an embodiment. The welding system 1 shown in FIG. 1 includes a welding robot 10, a robot controller 20, a power source device 30, a visual sensor 40, a data processor 50, and a teaching pendant 60.

The welding robot 10 shown in FIG. 1 is a six-axis articulated robot whose distal end has a welding torch 11 for gas metal arc welding (GMAW) attached thereto. Examples of GMAW include metal inert gas (MIG) welding and metal active gas (MAG) welding. In this embodiment, MAG welding will be described as an example. The welding robot 10 is not limited to a six-axis articulated robot and may be, for example, a portable compact robot. The welding robot 10 according to this embodiment has a touch-sensible configuration by detecting, for example, a change in electric current or voltage at the distal end. The sensing method is not limited to touch-sensing. Another sensing method may be used so long as the positional relationship between the welding torch 11 and a workpiece W can be detected.

The welding torch 11 is supplied with a welding wire 13 from a wire feeder 12. The welding wire 13 is fed toward a welding location from the distal end of the welding torch 11. The power source device 30 supplies electric power to the welding wire 13. This electric power causes an arc voltage to be applied between the welding wire 13 and the workpiece W, so that an arc occurs. The power source device 30 is provided with an electric current sensor (not shown) that detects a welding current flowing from the welding wire 13 being welded toward the workpiece W, and is also provided with a voltage sensor (not shown) that detects the arc voltage between the welding wire 13 and the workpiece W.

The power source device 30 has a processor and a storage unit that are not shown. The processor is constituted of, for example, a central processing unit (CPU). The storage unit is constituted of, for example, a volatile or nonvolatile memory, such as a hard disk drive (HDD), a read only memory (ROM), or a random access memory (RAM). The processor executes a power-controlling computer program stored in the storage unit, so as to control the electric power applied to the welding wire 13. The power source device 30 is also connected to the wire feeder 12, and the processor controls the feeding rate and the feeding amount of the welding wire 13.

The composition and the type of the welding wire 13 may be selected in accordance with the welding target. The type of the welding wire 13 may be, for example, a solid wire or a flux-cored wire containing flux. Examples of the material of the welding wire 13 include soft steel, stainless steel, aluminum, and titanium, and the wire surface may be plated with, for example, copper. Furthermore, the diameter of the welding wire 13 is not particularly limited.

The visual sensor 40 is constituted of, for example, a charge coupled device (CCD) camera. The installation position of the visual sensor 40 is not particularly limited. The visual sensor 40 may be attached directly to the welding robot 10, or may be fixed to a specific surrounding location to serve as a monitoring camera. If the visual sensor 40 is attached directly to the welding robot 10, the visual sensor 40 moves to photograph an area surrounding the distal end of the welding torch 11 as the welding robot 10 moves. The visual sensor 40 may be constituted of a plurality of cameras. For example, the visual sensor 40 may be constituted of a plurality of cameras having different functions and installed at different positions. Alternatively, the visual sensor 40 may be omitted.

The data processor 50 includes, for example, a CPU, a ROM, a RAM, a hard disk drive, an input-output interface, a communication interface, a video output interface, and a display unit (also referred to as “display” hereinafter) that are not shown. The data processor 50 may be constituted of an information processing device, such as a personal computer (PC). The data processor 50 may be used by an operator for performing various settings and management of the welding system 1.

The components constituting the welding system 1 are connected in a communicable manner in accordance with various wired/wireless communication methods. The communication method used is not limited to a single method, and the connection may be established using a combination of a plurality of communication methods.

### Configuration of Robot Controller

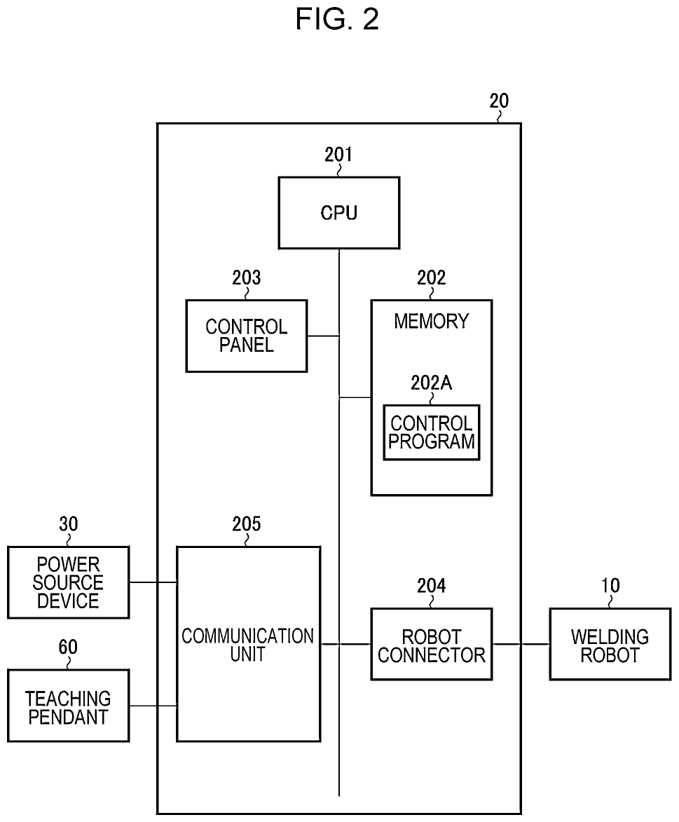

FIG. 2 illustrates a configuration example of the robot controller 20 that controls the operation of the welding robot 10. The robot controller 20 includes a CPU 201 that controls the entire robot controller 20, a memory 202 that stores data, a control panel 203 including a plurality of switches, a robot connector 204, and a communication unit 205. The memory 202 is constituted of, for example, a volatile or nonvolatile memory, such as a ROM, a RAM or an HDD. The memory 202 has stored therein a control program 202A used for controlling the welding robot 10. The CPU 201 executes the control program 202A to control various movements of the welding robot 10.

For inputting a command to the robot controller 20, the control panel 203 and the teaching pendant 60 can be used, and the teaching pendant 60 is mainly used. The teaching pendant 60 is connected to the robot controller 20 via the communication unit 205. The operator can use the teaching pendant 60 to input a teaching program. The robot controller 20 controls the welding robot 10 in accordance with the teaching program input from the teaching pendant 60 or a teaching program generated automatically in accordance with a method to be described later. The operational contents defined in the teaching program are not particularly limited and may vary depending on the specifications of the welding robot 10 and the welding method. The teaching pendant 60 can be used for manually manipulating the welding robot 10 via the robot controller 20. This embodiment is applied to the welding robot 10 of a teaching playback type. In this type, the operator can manually manipulate the welding robot 10 to perform a teaching process involving providing teaching points along a motion line and a weld line of the welding robot 10 and storing positions, storing coordinate information about the orientation of the welding robot 10, and inputting welding conditions. Accordingly, a teaching program to be used when causing the welding robot 10 to move automatically is created. If an error occurs in the middle of welding during automatic operation of the welding robot 10 and causes the welding robot 10 to stop, the operator can also manually operate the welding robot 10 by using the teaching pendant 60 and perform a correction process involving changing a target position.

The robot connector 204 is connected to a drive circuit of the welding robot 10. The CPU 201 outputs a control signal based on the control program 202A to the drive circuit (not shown) included in the welding robot 10 via the robot connector 204.

The communication unit 205 includes a communication module for wired or wireless communication. The communication unit 205 is used for data and signal communication with, for example, the power source device 30, the data processor 50, and the teaching pendant 60. The method and the standard of communication used by the communication unit 205 are not particularly limited, and may be a combination of a plurality of methods or may vary for each connected device. The power source device 30 transmits an electric current value of the welding current detected by the electric current sensor (not shown) and a voltage value of the arc voltage detected by the voltage sensor (not shown) to the CPU 201 via the communication unit 205.

The robot controller 20 controls the axes of the welding robot 10 to control the movement speed and the protruding direction of the welding torch 11. When weaving operation is to be performed, the robot controller 20 controls the weaving operation of the welding robot 10 in accordance with the set cycle, amplitude, and welding rate. The weaving operation involves oscillating the welding torch 11 alternately in a direction in which the welding progresses, that is, a direction intersecting with the welding direction. The robot controller 20 executes weld-line tracking control together with the weaving operation. Weld-line tracking control involves controlling left and right positions relative to the travelling direction of the welding torch 11 to form beads along the weld line. Furthermore, the robot controller 20 controls the wire feeder 12 via the power source device 30 so as to control, for example, the feeding rate of the welding wire 13.

In this embodiment, in addition to the fact that the teaching program can be generated and adjusted manually by using the teaching pendant 60 described above, the teaching program can also be generated automatically by the welding system 1. In this case, the welding system 1 performs an automatic generating process according to a sensing position to be described later, so as to generate the teaching program. Although the following description relates to the automatic generating process where the robot controller 20 automatically generates the teaching program, a part of the process may be executed by the data processor 50.

### Identification of Joint-Groove

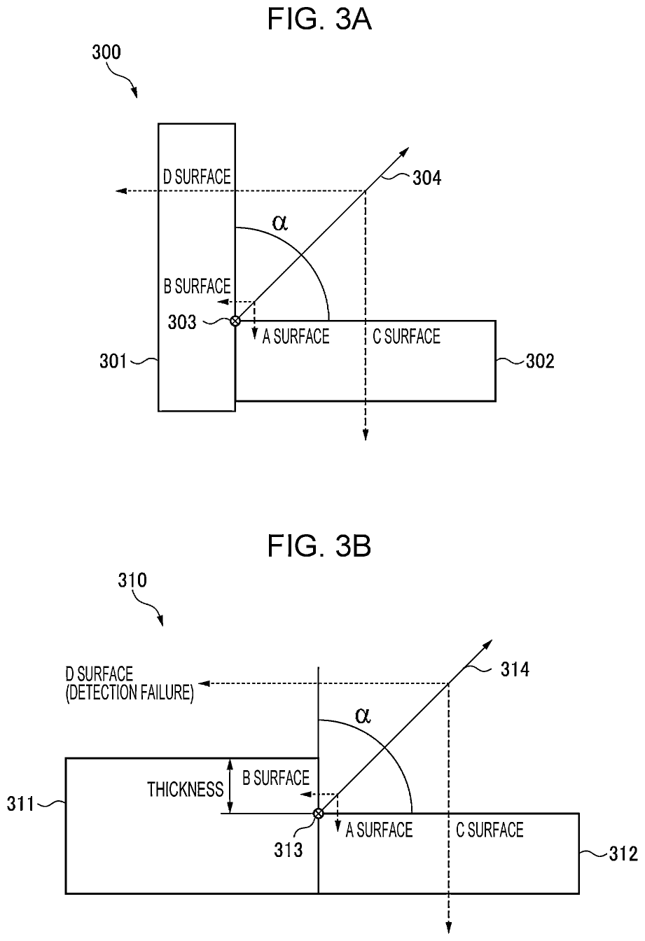

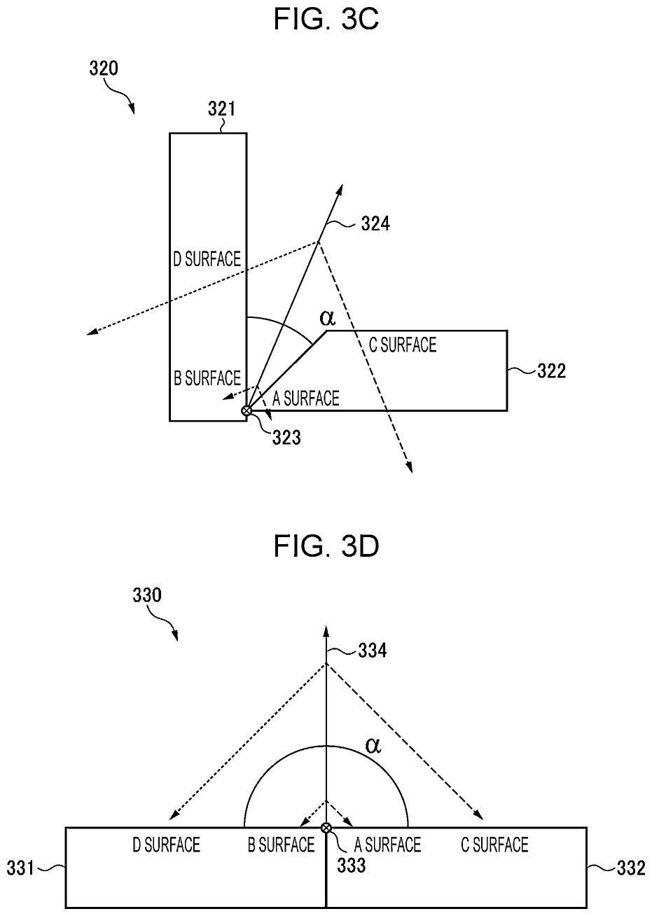

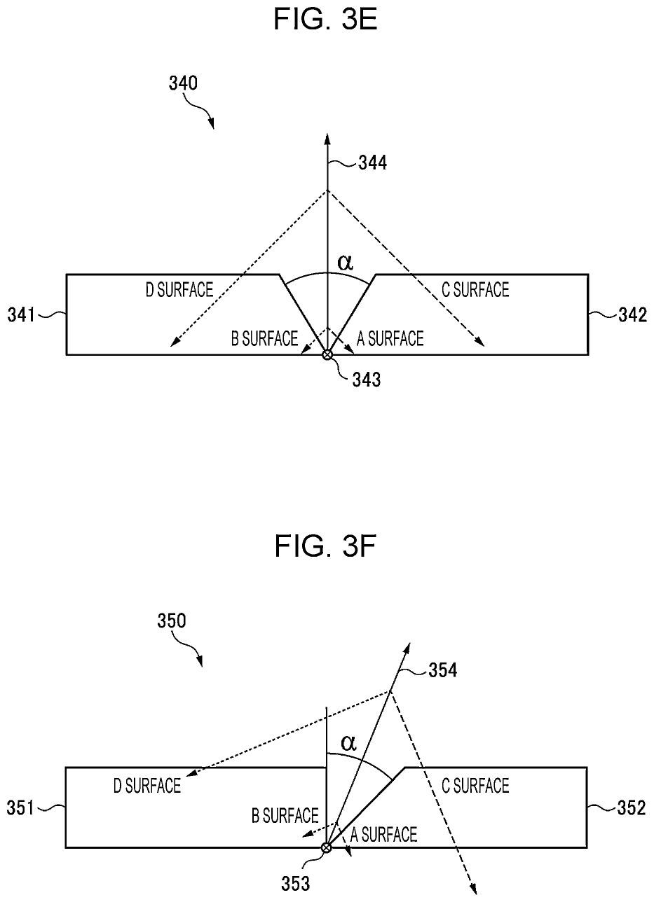

First, the joint-groove type of a weld line defined in the workpiece W according to this embodiment will be described with reference to FIGS. 3A to 3F. Examples of the joint-groove type include “T-joint fillet” shown in FIG. 3A, “step fillet” shown in FIG. 3B, “T-joint with single bevel groove” shown in FIG. 3C, “butt joint with square groove” shown in FIG. 3D, “butt joint with single V groove” shown in FIG. 3E, and “butt joint with single bevel groove” shown in FIG. 3F. In this embodiment, when identifying the sensing position, the component surfaces and the groove shape are identified. The joint-groove type is not limited to the above, and may include more types.

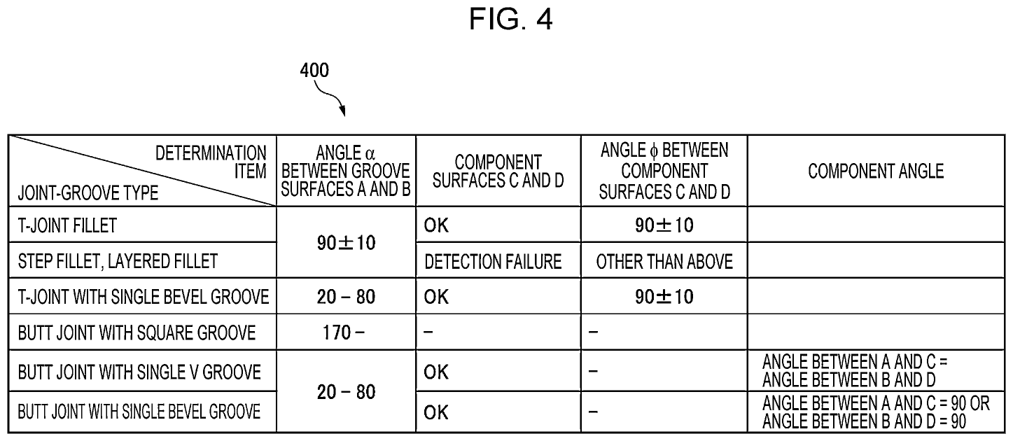

FIG. 4 illustrates a condition table 400 defining conditions for identifying the joint-groove type constituting the workpiece W. As shown in FIGS. 3A to 3F, six types are described as examples. Groove surfaces A and B, an angle α between the groove surfaces A and B, component surfaces C and D, and an angle φ between the component surfaces C and D that are identified in accordance with surfaces A, B, C, and D indicated in the condition table 400 in FIG. 4 correspond to locations shown in FIG. 3A to FIG. 3F.

It is assumed in this embodiment that the shape of each component, the weld line, and the vector of the groove direction of the weld line relative to the workpiece W are preliminarily defined as design data constituted by a three-dimensional model, such as computer-aided design (CAD) information. Furthermore, in this embodiment, a three-dimensional coordinate system based on each weld line is described as a coordinate system different from a robot coordinate system or a system coordinate system. The direction of the weld line (i.e., welding direction) will be defined as an X direction, and two directions orthogonal to the X direction will be defined as a Y direction and a Z direction, respectively. In order to simplify the description, an XY plane defined by the X direction and the Y direction will be defined as a horizontal direction, and the Z direction orthogonal to the XY plane will be defined as a height direction.

The T-joint fillet shown in FIG. 3A will now be described as an example. First, in a workpiece 300, a weld line 303 for welding a component 301 and a component 302 to each other and a vector 304 extending in the groove direction of the weld line 303 are identified from design data. Then, with reference to the position of the weld line 303, a search for surfaces of the components 302 and 301 located in predetermined directions from a predetermined position on an arrow indicated by the vector 304 is performed. The distance from the weld line 303 to the predetermined position will be referred to as “first distance” for the sake of convenience. For example, the first distance may be set to about 3 mm to 10 mm depending on the component size. The searching directions are two directions, and an angle formed between these two directions may be 90 degrees. In the case of the T-joint fillet, an A surface and a B surface are detected, as in the example in FIG. 3A, as a result of the search.

Furthermore, with reference to the position of the weld line 303, a search for surfaces of the components 302 and 301 located in predetermined directions from a predetermined position on the arrow indicated by the vector 304 is performed. The distance from the weld line 303 to the predetermined position will be referred to as “second distance” for the sake of convenience. For example, the second distance may be set to about twice the thickness of each component depending on the component size. In this case, the first distance is smaller than the second distance. The searching directions are two directions, and an angle formed between these two directions may be 90 degrees. In the case of the T-joint fillet, a C surface and a D surface are detected, as in the example in FIG. 3A, as a result of the search. The direction for performing the search for the surface from the position of the first distance and the direction for performing the search for the surface from the position of the second distance are aligned with each other.

Depending on the joint-groove type of the workpiece 300, some of the surfaces A, B, C, and D may sometimes be aligned with each other, or any of the surfaces A, B, C, and D may sometimes be undetectable. If a surface is not detectable as a result of performing a search at a fixed distance from a predetermined position on the arrow indicated by the vector, the searching process may be terminated.

The joint-groove type is identified in accordance with the angle α formed between the detected surfaces A and B, the detectability or non-detectability of the surfaces C and D, the angle φ formed between the detected surfaces C and D, and angles formed by the surfaces A, B, C, and D. In the case of FIG. 3A, the joint-groove type is identified as “T-joint fillet” based on the fact that the angle α formed between the surfaces A and B is almost equal to 90 degrees, the extraction of the surfaces C and D is successful, and the angle φ formed between the extracted surfaces C and D is almost equal to 90 degrees.

The joints shown in FIGS. 3B to 3F are similarly identified based on the conditions indicated in the condition table 400 in FIG. 4. FIG. 3B shows an example of “step fillet” and illustrates components 311 and 312, a weld line 313, a vector 314, and an example of detection based thereon. FIG. 3C shows an example of “T-joint with single bevel groove” and illustrates components 321 and 322, a weld line 323, a vector 324, and an example of detection based thereon. FIG. 3D shows an example of “butt joint with square groove” and illustrates components 331 and 332, a weld line 333, a vector 334, and an example of detection based thereon. FIG. 3E shows an example of “butt joint with single V groove” and illustrates components 341 and 342, a weld line 343, a vector 344, and an example of detection based thereon. FIG. 3F shows an example of “butt joint with single bevel groove” and illustrates components 351 and 352, a weld line 353, a vector 354, and an example of detection based thereon. For example, in the example shown in FIG. 3B, since the detection of the D surface has failed, “step fillet” is identified as a type different from the T-joint fillet based on this detection result.

The configuration of the condition table 400 is an example. The conditions may vary depending on, for example, the welding target or the configuration of the welding robot 10. Although not shown in FIG. 4, information corresponding to the first distance and the second distance and information related to the searching directions may be defined in the condition table 400.

### Setting of Sensing Points

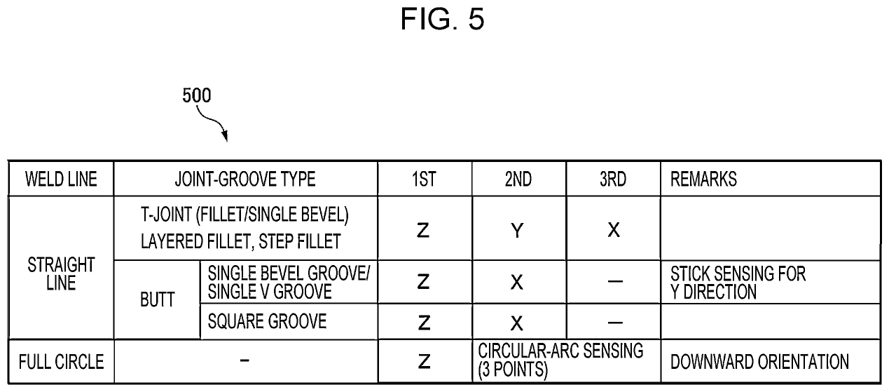

FIG. 5 illustrates an example of a sensing-point setting pattern defined in correspondence with the joint-groove type identified using any of FIGS. 3A to 3F and FIG. 4. It is assumed that a correspondence table 500 shown in FIG. 5 is set in advance. Sensing operation according to this embodiment may involve, for example, executing three-direction sensing, circular-arc sensing, and stick sensing as known touch-sensing techniques. The three-direction sensing is a method for individually sensing three axial positions of a workpiece in the X direction, the Y direction, and the Z direction. The three-direction sensing enables detection of a parallel error of the entire workpiece. The circular-arc sensing is, for example, a method involving sensing multiple points on a circular arc to detect a parallel error within a reference plane of a workpiece having a circular-arc shape with a fixed curvature. The stick sensing involves assuming a case where an error of the entire workpiece does not match an error of a groove and sensing near the groove from an orthogonal direction (Z direction) at a predetermined distance in a direction (Y direction) orthogonal to the welding direction, so as to detect the error of the groove. In the welding system 1 according to this embodiment, these sensing methods can be used in combination with each other.

As mentioned above, the X direction, the Y direction, and the Z direction are defined with respect to each weld line. For example, if the joint-groove type is the “T-joint fillet” relative to a straight weld line, the sensing points are set in the following order: “Z direction”, “Y direction”, and “X direction”. Likewise, if the joint-groove type is the “butt joint with single bevel groove” relative to a straight weld line, the sensing points are set in the following order: “Z direction” and “X direction”. In this case, stick sensing is performed for the Y direction. For a full-circular weld line, the sensing points are set such that the welding torch is oriented downward in the “Z direction”, and the circular-arc sensing is further performed.

The configuration of the correspondence table 500 is an example. The conditions may vary depending on, for example, the welding target, the configuration of the welding robot 10, or the sensing technique.

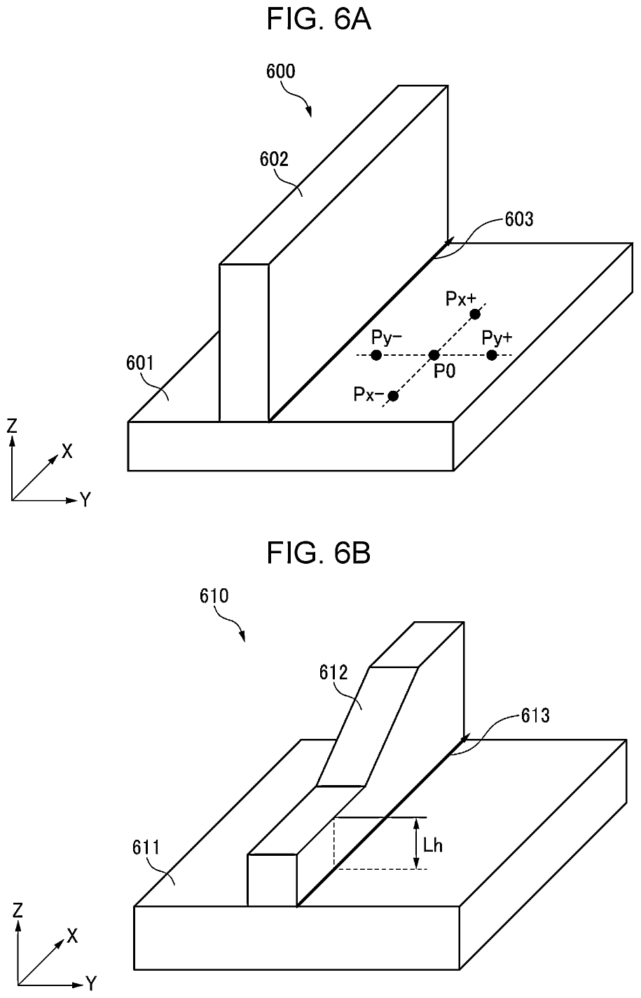

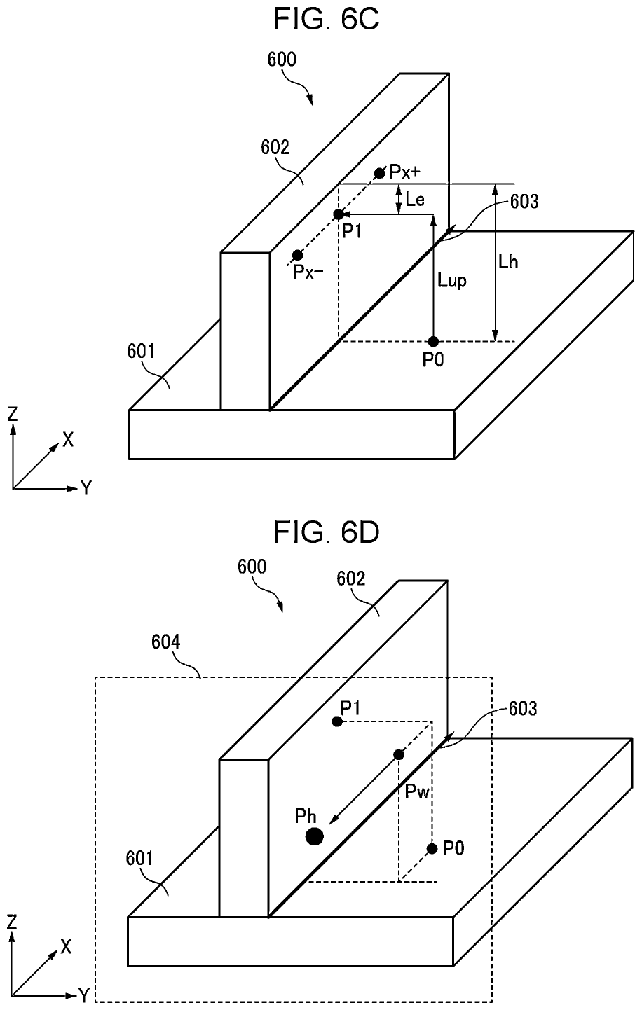

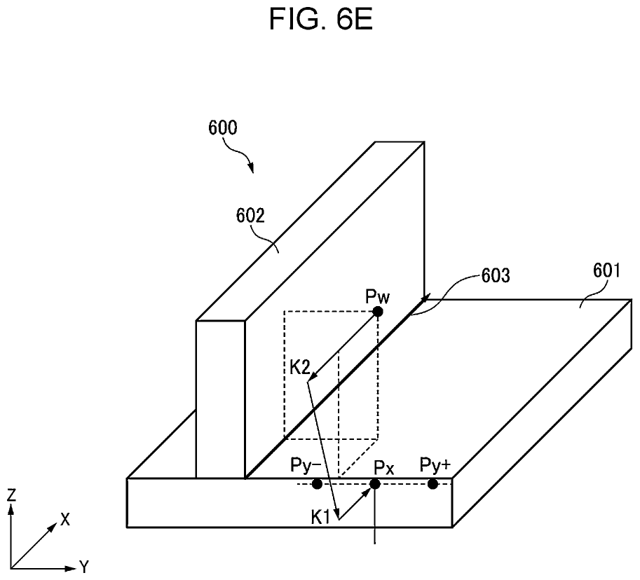

An example where the sensing points in the respective directions are set will now be described with reference to FIGS. 6A to 6E. FIG. 6A illustrates an area surrounding a weld line 603 defined between a component 601 and a component 602 of a workpiece 600 serving as a welding target. In FIG. 6A, the joint-groove type is identified as being the “T-joint fillet”. As shown in FIG. 5, the pattern for setting the sensing points is in the following order: “Z direction (height direction)”, “Y direction”, and “X direction (welding direction)”.

### Search for Z-Direction Sensing Point

First, a reference surface serving as a reference is selected in the components 601 and 602 having the weld line 603. In this case, a surface corresponding to the XY plane of the component 601 is defined as the reference surface. The method for selecting the reference surface is not particularly limited, and may be defined in advance based on, for example, the groove direction or the joint-groove type. A region where sensing is possible even when the workpiece 600 moves by a maximum permissible error amount preliminarily defined relative to the X direction and the Y direction is extracted, and a center position of the region is set as a candidate point P0 for a Z-direction sensing point. In the case of FIG. 6A, a region centered on the candidate point P0 and indicated by Px+ to Px− in the X direction and by Py+ to Py− in the Y direction is the region where sensing is possible.

For the sake of convenience, two directions defining the reference surface will be referred to as “first direction” and “second direction”. The first direction is the X direction, and the second direction orthogonal thereto is the Y direction. The correspondence between the first direction and the second direction is defined based on, for example, the reference surface as well as the configuration of the weld line. Therefore, the correspondence may vary. For the sake of convenience, a length in the first direction will be referred to as “first length”, and a length in the second direction will be referred to as “second length”. In the above example, the first length corresponds to the length between Px+ and Px−, and the second length corresponds to the length between Py+ and Py−. Although the region where sensing is possible in the search for the Z-direction sensing point is described here as an example, a search for a Y-direction sensing point and a search for an X-direction sensing point, to be described later, are also treated based on a similar concept.

For example, with regard to the workpiece 600, a maximum permissible error distance is defined as La, a clearance distance is defined as Lc, and a groove depth of a single bevel groove is defined as Ld. It is assumed that the maximum permissible error distance La and the clearance distance Lc are defined in advance. In this case, when the start point of the weld line 603 is defined as a reference (0, 0, Ld), an initial position for the Z-direction sensing point is P0 (X, Y, Z)=(La+Lc, La+Lc, Ld). If sensing is possible even by moving to Px+, Px−, Py+, and Py− as front, rear, left, and right positions in the XY plane relative to the initial position, it is determined that the region indicated by Px+, Px−, Py+, and Py− with P0 as the reference is the region where sensing is possible, and the center position P0 thereof is set as the Z-direction sensing point. It is assumed that the parameters of Px+, Px−, Py+, and Py− are defined in advance.

The values of Px+, Px−, Py+, and Py− may be the same or may be different from one another. Furthermore, different values may be used in accordance with the size of the welding target and the joint-groove type. For example, if Px+=Px−=Py+=Py−, the shape of a region defined based thereon is a square. In other words, by adjusting the values of Px+, Px−, Py+, and Py−, the shape of the region for determining the region where sensing is possible may be defined as a rectangular shape including a rhombus or a circular shape including an ellipse. In other words, by adjusting the values of Px+, Px−, Py+, and Py−, the first length in the first direction and the second length in the second direction may be adjusted.

If the region where sensing is possible is not identifiable at the initial position, the reference surface is scanned to search for a position where the range of the region indicated by Px+, Px−, Py+, and Py− is acquirable as the region where sensing is possible. As a result of the search, if the acquisition is not possible due to the reference surface being small, it may be determined that the Z-direction sensing point cannot be created.

### Search for Y-Direction Sensing Point

FIGS. 6B and 6C schematically illustrate a search for a Y-direction sensing point. When the Z-direction sensing point is set in accordance with the above-described method, an error amount in the Z direction is eliminated. Therefore, the Y-direction sensing point can be set without concerning about an error in the Z direction. In a workpiece 610 according to the example in FIG. 6B, a length in the Z direction of a side surface component 612 of a weld line 613 varies depending on the position in the X direction. Assuming such a case, a height to be sensed in the Y direction is adjusted to be lower than or equal to a lowest edge Lh of the side surface component 612, as shown in FIG. 6C, and is defined as Lup (Lup<Lh). An adjustment amount Le may be defined in advance in correspondence with, for example, the shape and size of the component.

In FIG. 6C, an initial position for the Y-direction sensing point is defined as P1 (X, Y, Z)=(La+Lc, 0, Lup). If sensing is possible even by moving to Px−, Px+ in view of the maximum permissible error amount in the X direction in an XZ plane, P1 is set as the Y-direction sensing point. In this case, Px−, Px+ is defined in advance, and the same value as the value used in the search for the Z-direction sensing point may be used. If a region where sensing is possible is not identifiable at the initial position, a search is performed in the X direction in the XZ plane, and a search for the position of the Y-direction sensing point where the sensing-possible region is acquirable is performed. As a result of the search, if the acquisition is not possible due to the side surface being small, it may be determined that the Y-direction sensing point cannot be created.

### Search for X-Direction Sensing Point

FIGS. 6D and 6E are schematic diagrams for explaining sensing in the X direction. FIG. 6D illustrates an example where a component 604 serving as a wall surface exists near the start point of the weld line 603. FIG. 6E illustrates an example where a component serving as a wall surface does not exist near the start point of the weld line 603. The X-direction sensing point is positionally set based on the following logic.

1. The component 604 serving as a wall surface exists near the start point of the weld line 603 and a projective point Ph is settable (FIG. 6D)

If a condition, such as no interference in the direction of a sensing path, is satisfied, the position of the projective point Ph on the component 604 is set as the X-direction sensing point. It is assumed that the condition is defined in advance based on, for example, the size and welding orientation of the welding torch 11. It is possible to determine from design data whether or not the component serving as the wall surface exists. A start position for the sensing in the X direction may be set as Pw, and Pw may be a position located at a predetermined distance from the wall surface in the X direction.

2. There is no component serving as a wall surface (FIG. 6E)

The X-direction sensing point is identified on an end surface of the component. First, an end surface of the component (in this example, the component 601 or the component 602) located toward the start position of the weld line is extracted, and a ridge line of the end surface is extracted. The end surface is located on a YZ plane. If there are multiple end surfaces, an end surface serving as a sensing target in the X direction is set in accordance with the distance from a point Pw defined with reference to the start point of the weld line. Then, the position on the ridge line is set as the X-direction sensing point. The flow of sensing in the X direction may involve setting the point Pw as the start point, and moving toward the X-direction sensing point on the ridge line via multiple retraction points (i.e., retraction points K2 and K1). In this case, the positions of the retraction points are set in view of an error of the workpiece in the X direction. In more detail, as shown in FIG. 6E, when moving toward the X-direction sensing point on the end surface from the retraction point K1, the position of the retraction point K1 is defined in view of a predetermined error amount.

As mentioned above, there are situations where the Z-direction sensing point and the Y-direction sensing point are not settable depending on, for example, the shape of the workpiece. If there is no component serving as a wall surface and the Z-direction sensing point and the Y-direction sensing point are settable, the X-direction sensing point may be set to a position at a predetermined distance from the ridge line of the end surface in the Y direction.

On the other hand, if there is no component serving as a wall surface and the Y-direction sensing point is not settable, it is assumed that an error in the Y direction has not been resolved. In this case, as shown in FIG. 6E, the X-direction sensing point Px is set to a position where the range of Py− to Py+ in the Y direction is included in the end surface. Accordingly, even if the workpiece has deviated in the Y direction, X-direction sensing is possible.

### Processing Flow

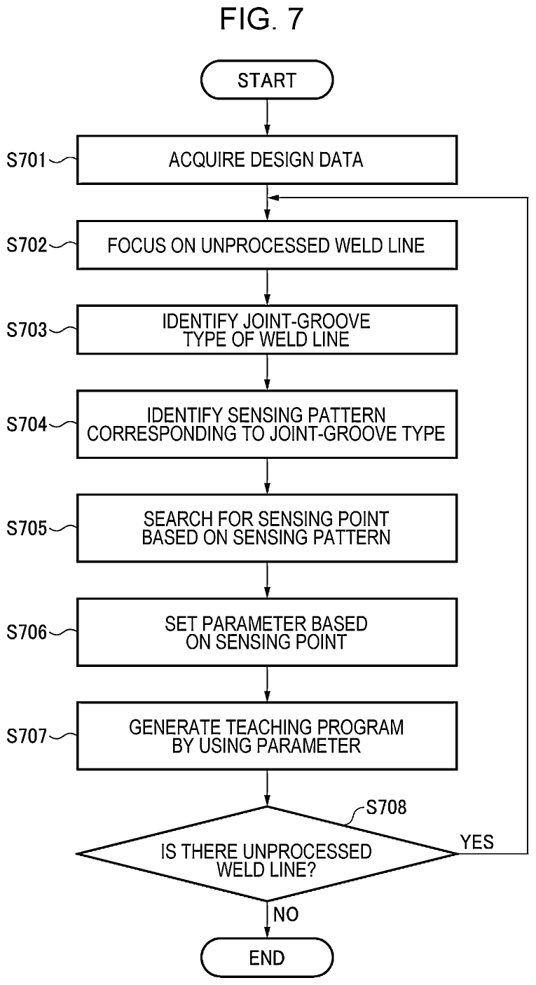

FIG. 7 is a flowchart illustrating a process for generating a teaching program according to this embodiment. For example, this processing flow is executed when the CPU 201 of the robot controller 20 reads a program and data stored in the memory 202. It is assumed that, before this processing flow starts, design data of a welding target is defined in advance and is usable.

In step S701, the robot controller 20 acquires the design data of the workpiece W serving as a welding target.

In step S702, the robot controller 20 focuses on one unprocessed weld line among multiple weld lines included in the design data acquired in step S701.

In step S703, the robot controller 20 identifies a joint-groove type based on information about the focused weld line. The identification method in this case is determined in accordance with the aforementioned method using FIGS. 3A to 3F and FIG. 4. For example, in the example shown in FIG. 3A, “T-joint fillet” is identified.

In step S704, the robot controller 20 identifies a sensing-point setting pattern based on the joint-groove type identified in step S703. The identification method in this case is performed based on the preliminarily-defined correspondence table 500 shown in FIG. 5.

In step S705, the robot controller 20 performs a search for sensing points based on the sensing-point setting pattern identified in step S704. The process in this case is performed in accordance with the method using any of FIGS. 6A to 6E. For example, in the case of “T-joint fillet”, the search for the sensing points is performed in the following order: the Z-direction sensing point, the Y-direction sensing point, and the X-direction sensing point.

In step S706, the robot controller 20 sets the parameter of each sensing point based on the search result in step S705. The parameter of each sensing point may include, in addition to the set sensing point, the coordinates of the sensing start point indicating the sensing start position and the sensing retraction point indicating the retraction position upon completion of the sensing. The sensing start point and the sensing retraction point may be set based on a correlation with the position of the set sensing point and a condition preliminarily defined with respect to calculation results up to step S705.

In step S707, the robot controller 20 generates a teaching program with respect to the focused weld line by using the parameter set in step S706. For example, the teaching program generated includes a path including the sensing start point, the sensing points, and the sensing retraction point.

In step S708, the robot controller 20 determines whether or not there is an unprocessed weld line in the design data acquired in step S701. If there is an unprocessed weld line (YES in step S708), the robot controller 20 returns to step S702 and repeats the process on the unprocessed weld line. In contrast, if there is no unprocessed weld line (NO in step S708), the robot controller 20 ends the processing flow.

According to this embodiment, a sensing position can be set automatically in view of an error of a workpiece, so that a sensing-related teaching program can be generated, thereby enabling reduced workload on a user.

### OTHER EMBODIMENTS

The present invention can be realized by supplying a program or an application for implementing the functions in at least one embodiment described above to a system or an apparatus by using, for example, a network or a storage medium, and causing at least one processor in a computer of the system or the apparatus to read and execute the program.

Furthermore, the present invention may be realized by a circuit that implements one or more functions. Examples of the circuit that implements one or more functions include an application specific integrated circuit (ASIC) and a field programmable gate array (FPGA).

Accordingly, the following items are disclosed in this description.

(1) A method for generating a teaching program that defines sensing operation comprises a setting step for setting a sensing position at a surface of a workpiece, and a generating step for generating a teaching program of the sensing operation based on the sensing position set in the setting step. The sensing position is set within a range in which a maximum permissible amount for an error of the workpiece and a permissible range preliminarily defined with respect to a direction of the error are included in the surface.

According to this configuration, the sensing position can be set automatically in view of the error of the workpiece, so that a sensing-related teaching program can be generated, thereby enabling reduced workload on a user.

(2) In the method according to (1), the setting step includes setting the range by searching for a position of the permissible range such that sensing is possible at a surface of the workpiece even when an error of the sensing position occurs.

According to this configuration, even when the error of the workpiece occurs, the sensing position is set where the sensing operation is possible, so that the teaching program can be generated automatically.

(3) In the method according to (2), the permissible range is defined at the surface in accordance with a first length (e.g., Px+ to Px−) in a first direction (e.g., X direction in FIG. 6A) and a second length (e.g., Py+ to Py−) in a second direction (e.g., Y direction in FIG. 6A) orthogonal to the first direction.

According to this configuration, the sensing position can be set by defining a range having an arbitrary shape as a permissible error range on the surface of the workpiece.

(4) In the method according to (2), the permissible range is defined to have a rectangular shape, a circular shape, or a rhombic shape at the surface.

According to this configuration, the sensing position can be set by defining a range having an arbitrary shape as a permissible error range on the surface of the workpiece.

(5) In the method according to (1), the setting step includes setting the range by searching for a position of the permissible range such that sensing is possible at a ridge line of the workpiece even when an error of the sensing position occurs.

According to this configuration, the sensing position can be set by defining a range having an arbitrary shape as a permissible error range on the ridge line of the surface of the workpiece.

(6) The method according to any one of (1) to (5) further comprises an identifying step for identifying a type of a joint and a groove of the workpiece, and a selecting step for selecting a pattern when setting the sensing position corresponding to the direction of the error of the workpiece based on the type identified in the identifying step. The setting step includes setting the sensing position based on the pattern selected in the selecting step.

According to this configuration, the sensing position can be set automatically based on the sensing-position setting pattern defined based on the joint-groove type of the workpiece.

An apparatus for generating a teaching program that defines sensing operation comprises setting means for setting a sensing position at a surface of a workpiece, and generating means for generating a teaching program of the sensing operation based on the sensing position set by the setting means. The sensing position is set within a range in which a maximum permissible amount for an error of the workpiece and a permissible range preliminarily defined with respect to a direction of the error are included in the surface.

According to this configuration, the sensing position can be set automatically in view of the error of the workpiece, so that a sensing-related teaching program can be generated, thereby enabling reduced workload on a user.

What is claimed is:

1. A method for generating a teaching program that defines sensing operation, the method comprising:
a setting step for setting a sensing position at a surface of a workpiece; and
a generating step for generating a teaching program of the sensing operation based on the sensing position set in the setting step,
wherein the sensing position is set within a range in which a maximum permissible amount for an error of the workpiece and a permissible range preliminarily defined with respect to a direction of the error are included in the surface.

2. The method according to claim 1,
wherein the setting step includes setting the range by searching for a position of the permissible range such that sensing is possible at a surface of the workpiece even when an error of the sensing position occurs.

3. The method according to claim 2,
wherein the permissible range is defined at the surface in accordance with a first length in a first direction and a second length in a second direction orthogonal to the first direction.

4. The method according to claim 2,
wherein the permissible range is defined to have a rectangular shape, a circular shape, or a rhombic shape at the surface.

5. The method according to claim 1,
wherein the setting step includes setting the range by searching for a position of the permissible range such that sensing is possible at a ridge line of the workpiece even when an error of the sensing position occurs.

6. The method according to claim 1, further comprising:
an identifying step for identifying a type of a joint and a groove of the workpiece; and
a selecting step for selecting a pattern when setting the sensing position corresponding to the direction of the error of the workpiece based on the type identified in the identifying step,
wherein the setting step includes setting the sensing position based on the pattern selected in the selecting step.

7. An apparatus for generating a teaching program that defines sensing operation, the apparatus comprising:
setting means for setting a sensing position at a surface of a workpiece; and
generating means for generating a teaching program of the sensing operation based on the sensing position set by the setting means,
wherein the sensing position is set within a range in which a maximum permissible amount for an error of the workpiece and a permissible range preliminarily defined with respect to a direction of the error are included in the surface.
